(19) United States
(12) Patent Application Publication
(10) Pub. No.: US 2025/0235827 A1
(43) Pub. Date: Jul. 24, 2025

(54) ELECTRIC FIELD ASSISTED NANOFILTRATION SYSTEMS

(71) Applicant: Purdue Research Foundation, West Lafayette, IN (US)

(72) Inventors: Yangyuan Ji, West Lafayette, IN (US); Linda S. Lee, West Lafayette, IN (US); David M. Warsinger, Carmel, IN (US)

(21) Appl. No.: 19/032,408

(22) Filed: Jan. 20, 2025

Related U.S. Application Data
(60) Provisional application No. 63/622,279, filed on Jan. 18, 2024.

(51) Int. Cl. B01D 61/42; C02F 1/461; C02F 1/469; C02F 101/36

(52) U.S. Cl. CPC B01D 61/42; C02F 1/46109; C02F 1/469; B01D 2313/14; B01D 2313/345; C02F 2001/46142; C02F 2101/36; C02F 2201/46115

(57) ABSTRACT

A fluid filtration apparatus includes a fluid reservoir containing a porous anode, a filtration membrane, and a porous cathode. A power source is coupled with each of the porous anode and porous cathode. The filtration membrane is positioned within the fluid reservoir spanning between the interior opposing end walls and fluidly divides the fluid reservoir into a first fluid cavity and a second fluid cavity. The porous anode is positioned within the first fluid cavity and the porous cathode is positioned within the second fluid cavity.

### CROSS-REFERENCE TO RELATED APPLICATIONS

This application is related to and claims the priority benefit of U.S. Provisional Patent Application No. 63/622,279, entitled “Electric Field Assisted Nanofiltration Systems,” filed Jan. 18, 2024, the contents of which are hereby incorporated by reference in their entirety into the present disclosure.

### TECHNICAL FIELD

The present application relates to a liquid filtration system and, more particularly, the present application provides systems including a nanofiltration membrane placed between reactive electrodes and methods which apply an electric field to the membrane system.

### BACKGROUND

This section introduces aspects that may help facilitate a better understanding of the disclosure. Accordingly, these statements are to be read in this light and are not to be understood as admissions about what is or is not prior art.

Per- and polyfluoroalkyl substances (PFAS) are a family of over 4000 synthetic fluoroalkyl compounds, which have been widely used all over the world. However, the high solubility, mobility, and persistence of PFAS have led to their widespread migration and distribution into aquatic environments through many water sources, including wastewater discharge. PFAS are responsible for causing adverse effects on the human body, with ample evidence correlating PFAS consumption with liver disease and cancer, damaged immunity and thyroid function, and lower birth weight. One main human exposure route to PFAS is ingestion of drinking water; PFAS from water sources can be transported to consumers through drinking water treatment and distribution systems, as exemplified by the high detection frequency in drinking water. PFAS chemicals are more toxic than previously realized, causing the US Environmental Protection Agency to lower the health advisory level of perfluorooctanoic acid (PFOA) in drinking water from 70 ng/L (combined with perfluorooctanesulfonate) to 0.004 ng/L in 2022. Notably, PFOA has the typical chemical structure of other PFAS compounds, containing a C—F chain and carboxylic acid end, making PFOA a representative compound to understand electrochemical degradation mechanisms of PFAS.

Unfortunately, due to the strength of the C—F bond, PFAS are challenging to remove and are characterized as having poor biodegradability and high thermal and chemical stability. Conventional disinfection processes (e.g., coagulation and chemical oxidation) in drinking water treatment plants are ineffective for PFAS removal. In comparison, advanced oxidation/reduction processes, such as sonochemical, photochemical, and plasma technology, have made some progress in effectively eliminating PFAS in indusial wastewater and have the potential to treat drinking water. However, these processes require high energy consumption and long batch processing time, limiting their commercial application and widespread use.

### SUMMARY

Accordingly, described herein is a fluid filtration apparatus which can include a fluid reservoir, a filtration membrane, a porous anode, a porous cathode, a first fluid port, and a second fluid port. The fluid reservoir can define an external surface and an interior cavity, and the interior cavity can define opposing end walls. The filtration membrane can be positioned within the fluid reservoir spanning between the interior opposing end walls, and the filtration membrane can fluidly divide the fluid reservoir into a first fluid cavity and a second fluid cavity. The porous anode can be positioned within the first fluid cavity, and the porous anode can be configured to selectively receive a first power signal thereto. The porous cathode can be positioned within the second fluid cavity, and the porous anode can be configured to selectively receive a second power signal thereto. The first fluid port can be disposed through the external surface of the fluid reservoir and configured to fluidly couple with the first fluid cavity. The second fluid port can be disposed through the external surface of the fluid reservoir and configured to fluidly couple with the second fluid cavity.

In another aspect of the disclosure, a fluid filtration apparatus can include an elongate fluid conduit, a power source, and a plurality of planar sheets. The elongate fluid conduit can include an open inlet end for receiving fluid, and a plurality of perforations along its length. The plurality of planar sheets can each be composed of a porous material, each having a first edge secured to the elongate fluid conduit proximate to the perforations and a second edge configured to be wrapped around the conduit to form multiple overlapping layers covering the perforations. A fluid can be introduced into the conduit such that it exits through the perforations and passes through one or more of the plurality of planar sheets. Further, the plurality of planar sheets can include an anode sheet coupled with the power source, a cathode sheet coupled with the power source, a first filtration sheet, and a second filtration sheet.

In another aspect of the disclosure, a fluid filtration apparatus can include a fluid reservoir, a power source, an anode, and a ceramic conductive membrane. The fluid reservoir can define an external surface and an interior cavity, and the interior cavity can define opposing first and second end walls. The anode can be positioned within the interior cavity spanning from the first end wall to the second end wall, and the anode can be configured to selectively receive a first power signal thereto from the power source. The ceramic conductive membrane can be positioned within the interior cavity adjacent to the anode and spanning from the first end wall to the second end wall. The ceramic conductive membrane can be configured to selectively receive a second power signal thereto from the power source. The anode and cathode can each be formed of porous materials.

This summary is provided to introduce a selection of the concepts that are described in further detail in the detailed description and drawings contained herein. This summary is not intended to identify any primary or essential features of the claimed subject matter. Some or all of the described features may be present in the corresponding independent or dependent claims but should not be construed to be a limitation unless expressly recited in a particular claim. Each embodiment described herein does not necessarily address every object described herein, and each embodiment does not necessarily include each feature described. Other forms, embodiments, objects, advantages, benefits, features, and aspects of the present disclosure will become apparent to one of skill in the art from the detailed description and drawings contained herein. Moreover, the various apparatuses and methods described in this summary section, as well as elsewhere in this application, can be expressed as a large number of different combinations and subcombinations. All such useful, novel, and inventive combinations and subcombinations are contemplated herein, it being recognized that the explicit expression of each of these combinations is unnecessary.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

While the specification concludes with claims which particularly point out and distinctly claim this technology, it is believed this technology will be better understood from the following description of certain examples taken in conjunction with the accompanying drawings, in which like reference numerals identify the same elements and in which:

FIG. 1A depicts a schematic view of one exemplary electric field-assisted nanofiltration system having a polymer-based membrane, shown in the batch mode of operation;

FIG. 1B depicts a schematic view of the SnO₂—Sb porous anode of the electric field-assisted nanofiltration system of FIG. 1A, showing (1) an enlarged top view and (2) an enlarged cross-sectional view;

FIG. 1C depicts images showing a composition examination of the SnO₂—Sb porous anode of FIG. 1B, showing (1) an SEM image of a typical cross-sectional view SnO₂—Sb porous anode, (2) the merged image of (3) and (4), (3) an SEM-EDX elemental mapping image of Ti, and an SEM-EDX elemental mapping image of Sn;

FIG. 1D depicts a schematic view of a variation of the electric field-assisted nanofiltration system of FIG. 1A, shown in the cyclic crossflow mode of operation;

FIG. 2 depicts comparative schematic diagrams of a PFOA rejection performance by applying an electric field in the same direction and opposite direction as filtration, showing schematics of the membrane cell in (a1) standard and (b1) reverse orientation filtering modes with the membrane system operated in cyclic crossflow mode, schematics of the electric field and the pressure driving force acted on PFOA in (a2) standard and (b2) reverse orientation filtering modes, and a PFOA rejection performance at different applied voltages in standard (a3) and reverse (b3) orientation filtering modes;

FIG. 3 depicts a graphical representation of the results of a crossover experiment of transmembrane pressure and applied voltage on % PFOA rejection in standard orientation mode, where the PFOA rejection was examined by the crossover study of applied voltage (0-90 V) and transmembrane pressure (1.38-6.89 bar), with the membrane system operated in cyclic crossflow mode, showing the % rejection of PFOA being divided into two zones: zone I from 0 to 20 V and zone II from 20 to 90 V;

FIG. 4A depicts a graphical representation of PFOA concentration in feed tank and permeate relative to the percent of PFOA rejection during a 48-hour, long-term filtration, where the transmembrane pressure was 4.14 bar (60 psi) and the membrane cell was on the standard orientation mode while the membrane system operated in batch mode, showing the control group when the membrane system was run without applying an electric field;

FIG. 4B depicts a graphical representation of PFOA concentration in feed tank and permeate relative to the percent of PFOA rejection during a 48-hour, long-term filtration, where the transmembrane pressure was 4.14 bar (60 psi) and the membrane cell was on the standard orientation mode while the membrane system operated in batch mode, showing the electric field-assisted group when the applied voltage of electric field was 30 V;

FIG. 5A depicts a graphical representation of a 48-hour, long-term filtration and degradation performance under saline feed (30 V, 1 mM NaSO4) using a standard orientation of the membrane cell and the batch mode of the membrane system, correlating the percent PFOA removal, the concentration of PFOA (μg/L) in feed and permeate, and F⁻ concentration in feed tank;

FIG. 5B depicts a graphical representation of various concentrations of PFCAs (μg/L) as electro-oxidation decomposition products in feed tank during the 48-hour filtration process, comparing PFBA, PFPeA, PFHxA, and PFHpA;

FIG. 5C depicts a graphical representation of percent recovery of fluorine during the treatment process from PFOA, the decomposition products, and F;

FIG. 5D depicts a schematic of PFOA degradation and rejection in saline feed;

FIG. 6A depicts a graphical representation of a comparison of water flux and percent PFOA removal for various operation conditions and NF membranes, showing the water flux of electric field-assisted nanofiltration system under different feeds and applied voltages: saline feed with 30 V, saline feed with 10 V, saline feed with 0 V, non-saline feed with 30 V, and non-saline feed with 0 V;

FIG. 6B depicts a graphical representation of a comparison of percent PFOA removal and water flux of a commercial NF membrane;

FIG. 7 depicts a schematic view of another exemplary electric field-assisted nanofiltration system having a ceramic-based membrane;

FIG. 8A depicts a schematic view of another embodiment of an electric field-assisted nanofiltration system, shown in a spiral configuration;

FIG. 8B depicts a cross-sectional view of the electric field-assisted nanofiltration system of FIG. 8A, showing an enlarged section view notating liquid flows therethrough; and

FIG. 9 depicts a schematic view of another embodiment of an electric field-assisted nanofiltration system, shown in a hollow fiber membrane configuration.

The drawings are not intended to be limiting in any way, and it is contemplated that various embodiments of the technology may be carried out in a variety of other ways, including those not necessarily depicted in the drawings. The accompanying drawings incorporated in and forming a part of the specification illustrate several aspects of the present technology, and together with the description serve to explain the principles of the technology; it being understood, however, that this technology is not limited to the precise arrangements shown, or the precise experimental arrangements used to arrive at the various graphical results shown in the drawings.

### DETAILED DESCRIPTION

The following description of certain examples of the technology should not be used to limit its scope. Other examples, features, aspects, embodiments, and advantages of the technology will become apparent to those skilled in the art from the following description, which is by way of illustration, one of the best modes contemplated for carrying out the technology. As will be realized, the technology described herein is capable of other different and obvious aspects, all without departing from the technology. Accordingly, the drawings and descriptions should be regarded as illustrative in nature and not restrictive.

It is further understood that any one or more of the teachings, expressions, embodiments, examples, etc. described herein may be combined with any one or more of the other teachings, expressions, embodiments, examples, etc. that are described herein. The following-described teachings, expressions, embodiments, examples, etc. should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

### I. Overview

Per- and polyfluoroalkyl substances (PFAS) pose significant environmental and human health risks and thus require solutions for their removal and destruction. However, PFAS cannot be destroyed by widely used removal processes like nanofiltration (NF). A few scarcely implemented advanced oxidation processes can degrade PFAS. As illustrated in the drawings and described herein, an electric field may be applied to a membrane system by placing a nanofiltration membrane between reactive electrodes in a crossflow configuration. The performance of perfluorooctanoic acid (PFOA) rejection, water flux, and energy consumption can be evaluated. The reactive and robust antimony-doped tin dioxide (SnO₂—Sb)-coated porous anode may be created, for example, via a sintering and sol-gel process. The PFOA rejection with these components may be increased when an electric field and filtration grow in the same direction in non-saline solutions. The proximity between the electrodes and membrane provides at least one reason why the approach succeeded in increasing PFOA rejection. Accordingly, the proposed electric field-assisted nanofiltration design provides an improved membrane separation method for PFAS removal from water or other liquids.

### II. Materials and Methods

### A. Materials and Chemicals

In one experiment, the cathode and the anode substrate were porous titanium discs (e.g., diameter of 100 mm and thickness of 1 mm) that were custom made using a vacuum sintering method. Furthermore, oxalic acid (>99%), tin (IV) chloride (>98%), antimony (III) chloride (>99%), ethanol (>99.5%), citric acid (>99%), and ethylene glycol (>99%) were used to synthesize the SnO₂—Sb porous anode. The PFOA (>95%) and sodium sulfate (>99.0%) were used as a target contaminant and an electrolyte, respectively. All the chemicals were analytical reagent grade and used as received without further purification. The nano-grade water for all the solutions used in the experiment was produced from an ultra-purified water system. PFAS analytical standards (PFAC-24PAR) and isotopes (MPFAC-MXA) for analysis were used, and methanol, ammonium acetate, and isopropanol were used at HPLC or a higher grade. The polymer polyamide-TFC nanofiltration membrane was used with a molecular weight cutoff of around 600-800 Da. The membrane cell was composed of two pieces of 6″× 6″× 1″ polycarbonate plastic. It should be understood that the above materials and chemicals as described were used for the experimentations to produce the results described herein but should not be treated as limiting the scope of the advantageous nanofiltration systems and methods described.

### B. Porous Electrode Fabrication

The SnO₂—Sb porous anode was synthesized by a modified sol-gel method, followed by a sol-gel preparation, substrate pretreatment, dip coating, and thermal decomposition. The citric acid and ethylene glycol were mixed and heated at 75° C. for 0.5 h, while SnCl₄·4H₂O and SbCl₃ were used as the tin and antimony source, respectively, and were added to the mixture in a specific molar ratio (citric acid/ethylene glycol/SnCl₄·4H₂O/SbCl₃=140:30:9:1). This mixture was then stirred at 95° C. for around 4 hours to obtain the sol-gel. Before the coating process, the titanium substrates were etched in boiling oxalic acid solution (10%, m/m) for around 2 hours. After dip coating, the titanium plate was dried at 120° C. for around 10 min and sintered at 450° C. for the sol-gel thermal decomposition. The coating stage was repeated around 20 times to obtain the SnO₂—Sb coating porous anode. The SnO₂ layer was successfully loaded on the porous titanium substrate. The final loading mass of the SnO₂ layer per gram substrate (20 coating layers) was around 23.1 mg/g.

### D. Electric Field Assisted Nanofiltration System

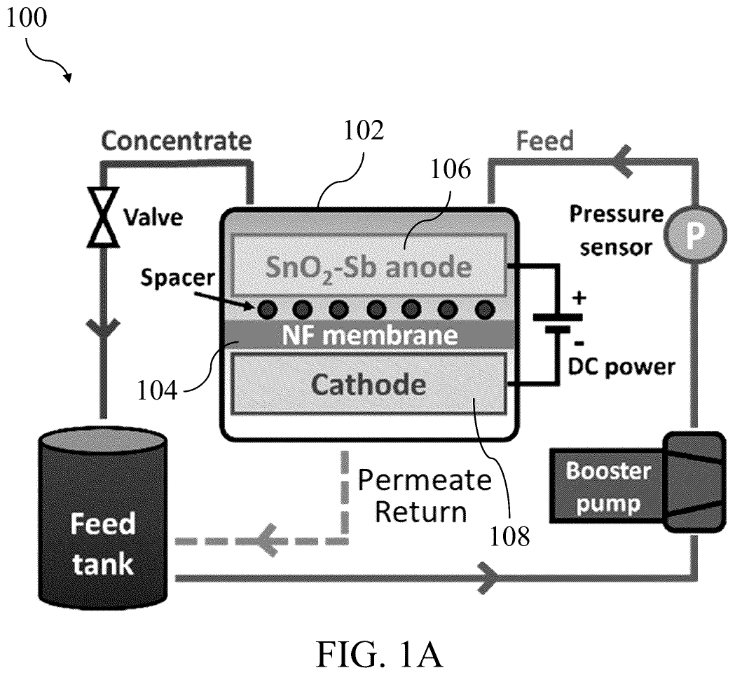

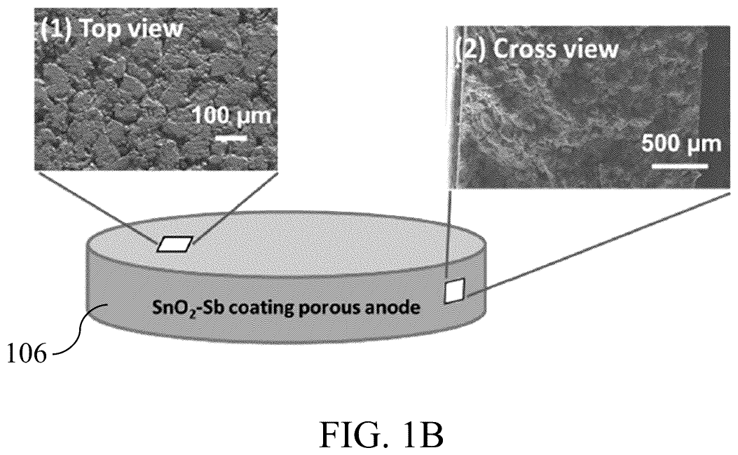

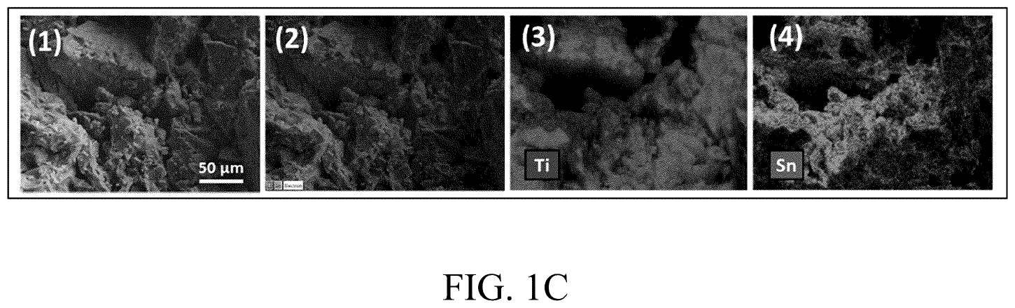

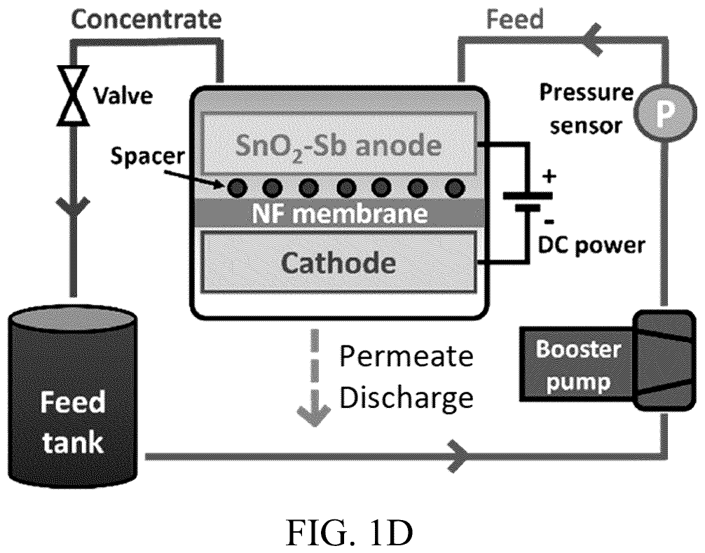

FIG. 1A shows a schematic of one electric field-assisted nanofiltration system (100). The membrane cell, as shown in greater detail in FIGS. 1B and 1C, is an important component of the electric field assisted nanofiltration system (100). The membrane cell (102) is defined by a fluid tight housing or enclosure which houses an NF membrane (104) (e.g., a polymer-based membrane) and electrodes (106, 108) positioned within. The electrodes are separated by the NF membrane (104) and are respectively placed into separate anode and cathode chambers within the membrane cell (102). The cathode may additionally function as a support for the NF membrane (104) within the enclosure (102), which will not damage the selection properties of the functional layer and the separation process. Furthermore, a plastic mesh spacer (110) may be placed on the surface of the NF membrane (104) to promote turbulence and mass transfer, while an O-ring and a cut silicone sheet may be used for sealing. The feed and concentrate may be located at the anode chamber side, and the filtrated water flowing through the anode-membrane-cathode can be released from permeate effluent at the cathode chamber side. Further, the transmembrane pressure for the filtration process can optionally be provided by a booster pump, and the pressure can optionally be controlled by a needle valve on the concentrate pipeline. A power supply, such as a DC power supply, may also be used to supply electrical energy to the anode (106) and cathode (108) for the electric field. For the experimental results provided herein, a pressure sensor and processor were used for data recording.

Further, the system (100) may be selectively operated in two different modes: batch mode (shown in FIG. 1A) and/or cyclic crossflow mode (shown in FIG. 1D). The batch mode of operation (see, FIG. 1A) may be selected, for example, for the electro-oxidation degradation of pollutants by sending the permeate water into the feed tank. The cyclic crossflow mode of operation (see, FIG. 1D) may be selected, for example, for on-line water production, such as connected to the tap water pipe, where the permeate water is directly discharged into the boost pump intake.

As the anode shows catalytic and degradation abilities in the electro-oxidation processes, various combinations of porous materials may be used for the anode. For example, rather than titanium, platinum or silver may be used as a precious metal, any one or more of PbO₂, SnO₂, IrO₂, RuO₂, or Ti₄O₇ may be used as the metal oxide, and any one or more of graphite or carbon-based material (e.g., carbon paper, carbon felt, carbon fiber, or carbon nanotube) may be used as a carbon material, or a conductive polymer. The porous cathode materials may be, for example, porous titanium metals or a carbon-based material. The above examples are not intended to represent an exhaustive list of available materials for these electrodes.

Additionally, the voltage range used may impact the rejection performance. The design can realize a direct current electric field above 100 V, which means the electric field intensity could be above 103 V/mm. In experiments, 30 V (300 V/mm) was sufficient to meet the processing requirements. Existing technology is fragile due to the material load on the membrane surface and thus may be used in a voltage range of 1-10 V.

### E. Filtration Experiments

The general feed (non-saline) was composed of pure water, and the saline feed contained 1 mM (142 mg/L) sodium sulfate as the electrolyte; the initial concentration of the target contaminant PFOA was 0.5 mg/L, and the pH of all feeds was unadjusted. The electric field-assisted nanofiltration system (100) was constructed with continuous crossflow filtering and operated within a transmembrane pressure range of 1.38-6.89 bar and an applied voltage range of 0-90 V. Based on the recovery or discharge of the permeate, the operation of the membrane system was divided into batch mode and cyclic crossflow mode. Before each experiment, the NF membrane was run with pure water at 4.14 bar (60 psi) for at least 1 hour until the permeate flux was stable. The sampling ports of the feed and permeate were at the feed tank and the permeate output, respectively. The water samples (5 mL) of feed and permeate were taken to determine PFOA concentration; the PFOA rejection percentage was calculated and permeate collected within a specific time interval was used to calculate water flux. A long-term (e.g., 48-hour) filtration test was conducted at a transmembrane pressure of 4.14 bar, and the water flux and water samples were collected every 8 hours. Multiple membranes were used in the experiments, and each experiment was run three times to minimize error.

### F. Filtering Modes

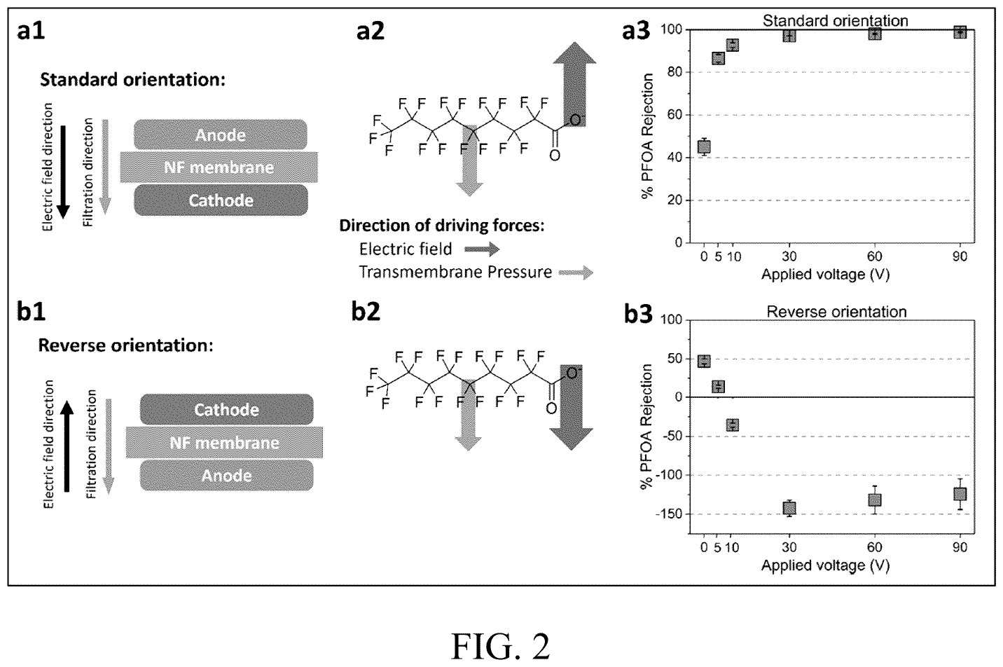

Two filtration modes were conducted by switching the electric field direction by changing the anode and cathode positions. In standard orientation mode, shown in FIG. 2 (a1), the filtration sequence of permeate was as follows: anode-membrane-cathode. Thus, the electric field direction and filtering direction were the same, resulting in the electric field driving force and the pressure driving force on ionized PFOA being in opposite directions, shown in FIG. 2 (a2). Moreover, in the reverse orientation mode, shown in FIG. 2 (b1), the electric field direction was opposite to the filtering direction. Thus, the electric field driving force and the pressure driving force acted on the ionized PFOA in the same direction, shown in FIG. 2 (b2).

### G. Operational Modes

A first operational mode may be an electrically assisted membrane filter mode. In this mode, the salinity of the feed water could be ≤1 mM (e.g., surface water, tap water), and the electric field strength between the electrodes could be more than 10 V/mm. The electrode spacing may be in the range of 0.1-5 mm and the applied voltage less than 60V to inhibit the water electrolytic reactions.

A second operational mode may be an electro-chemical reactor mode. In this mode, the salinity of the feed water could be >1 mM (e.g., groundwater, reuse water), and the electrodes spacing could be in the range of 0.1-5 mm. The applied voltage in this mode would be more than 10V.

### H. PFAS Analysis

Water samples were prepared by adding isotopes to the final sample composition in 1:1 H₂O/MeOH and analyzed for PFOA and associated degradation products using a liquid chromatograph coupled with a triple quadrupole mass spectrometer operated in negative electrospray ionization mode. A delay column (e.g., allowing 5 μm of fully porous, spherical particles to pass through) was installed before the analytical column to minimize any interference from the LC solvents. The analytical column used a guard filter and was maintained at 40° C. with the injection volume at 10 μL. The mobile phase consisted of 20 mM ammonium acetate in water (A) and methanol (B) at a flow rate of 0.4 mL/min. The gradient started at 10% B, increased to 50% in the first 0.5 min, was maintained for 8 minutes, increased to 99% B, was held for 5 minutes before returning to 10% B over a 0.5-minute window, and then was maintained for 20 minutes. Data was acquired with multiple reaction monitoring (MRM) and processed using Labsolution software. Fluoride and sulfate concentrations were determined by ion chromatography using 3.2 mM sodium carbonate, 1.0 mM sodium bicarbonate eluent, and a Metrosep Supp 4-250/4.0 column. The electrolyte concentration and pH of the water samples were measured using a multimeter and pH meter, respectivley.

### III. Discussion

### A. Characterization of Porous Electrodes

The micron-scale pores inside the SnO₂—Sb porous anode (106) can be observed with a top view and cross-view of the porous anode (106), shown in FIG. 1B. Therefore, the water stream passes through the porous anode (106) during filtration. An element mapping overlay of Sn and Ti in cross-view is shown in FIG. 1C, which indicates that the SnO₂ layer was successfully coated on the Ti substrate and confirms that the SnO₂ layer is continuous and dense. The SnO₂ may be the main crystal form in the porous anode (106). As displayed in survey spectra, the Sn peak appeared in the Ti substrate after coating. The pore size of the Ti substrate decreased from 4.25 to 3.25 μm after SnO₂ layer coating.

### B. Electric Field Direction

The effects of the electric field direction (i.e., standard and reverse orientation) on PFOA rejection were examined. In the experiment, the transmembrane pressure was kept at 4.14 bar (60 psi), while the applied voltage was increased in a gradient from 0 to 90 V. In the mode of standard filtering orientation, shown in FIG. 2 (a1), the electric force attempted to drive PFOA away from the NF membrane, shown in FIG. 2 (a2), while the mechanical force of transmembrane pressure was driving PFOA toward the NF membrane (104). Increasing of the electric voltage from 0 to 30 V resulted in the PFOA rejection rising from 45% to 97%, shown in FIG. 2 (a3). In contrast, in the mode of reverse filtering orientation, shown in FIG. 2 (b1), both the electric field and transmembrane pressure forced PFOA to pass through the NF membrane (104), shown in FIG. 2 (b2), causing the value of PFOA rejection to be negative when the applied voltage was applied at a quantity greater than 5 V, shown in FIG. 2 (b3). This negative value means that PFOA penetrates rapidly through the NF membrane (104), concentrating in the permeate. This concentrating is possible due to concentration polarization, meaning that the PFOA concentration near the NF membrane (104) surface was higher than that in the feed, resulting in a higher PFOA concentration in the permeate (Cp) than that in the feed (Cf). In this scenario, nanofiltration is not only driven by high transmembrane pressure but also the electric field driving force was newly introduced via the charged electrodes (106, 108), and the electric field direction significantly affects the penetration and retention of PFOA in the system (100).

### C. Electric Field Driving Force Versus Pressure Driving Force

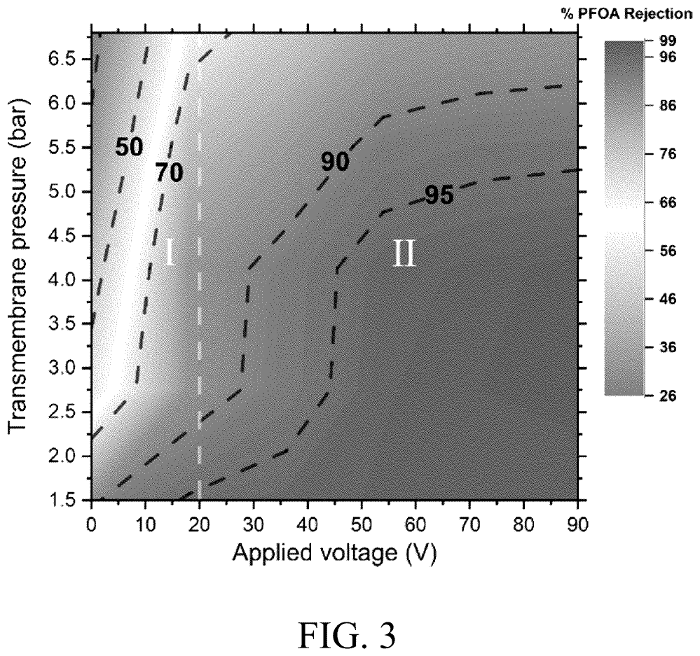

The relationship between PFOA rejection, electric field driving force, and pressure driving force is clarified below. According to the manufacturer, the NF membrane used in this study has good size selectivity, and the rejection of uncharged and organic compounds was around 600-800 Da. Due to the moderate molecular weight of PFOA (414 g/mol, 414 Da), thus, PFOA rejection was related to the transmembrane pressure. An increase in the transmembrane pressure directly leads to a decrease in the % rejection. Therefore, the % PFOA rejection was examined in a crossover experiment of the transmembrane pressure and applied voltage, where the pressure varied from 1.38 to 6.89 bar and the applied voltage varied from 0 to 90 V. The examined PFOA rejection data were divided into zones I and II, as shown in FIG. 3. The applied voltage was below 20 V in zone I, and the electric field driving force was weak and could not counteract the pressure driving force, resulting in poor PFOA rejection performance (<70%); driven by the strong electric field in zone II (>20 V), the PFOA rejection was enhanced, and the PFOA rejection was greater than 70% across the pressure range. In general, the rejection of PFOA was significantly improved by the applied voltage at the full range of transmembrane pressures in this membrane system. Thus, the size exclusion and concentration polarization were no longer the key dominant factors for this filtration process, but rather electrical activity was.

### D. Filtration Stability in Non-Saline Feed

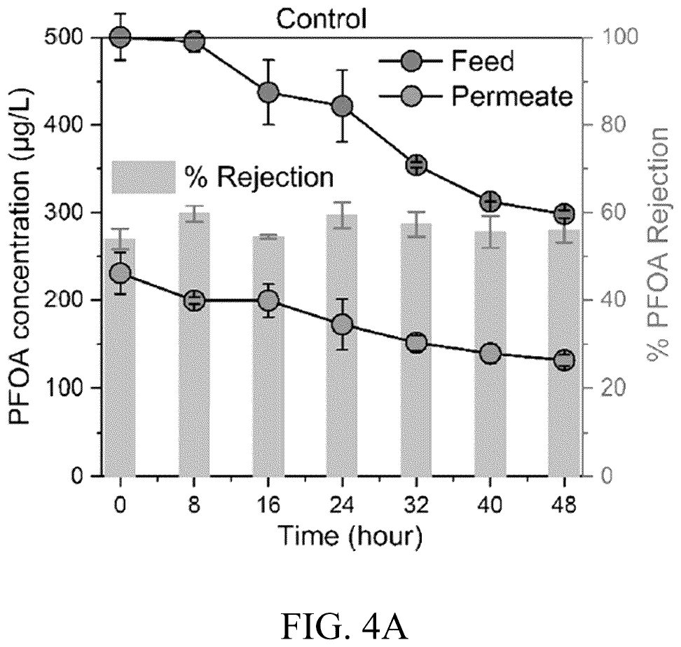

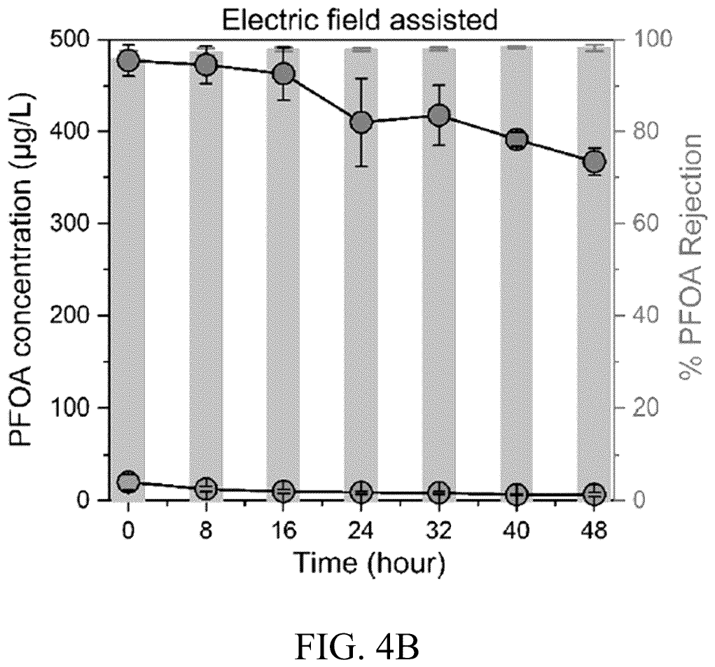

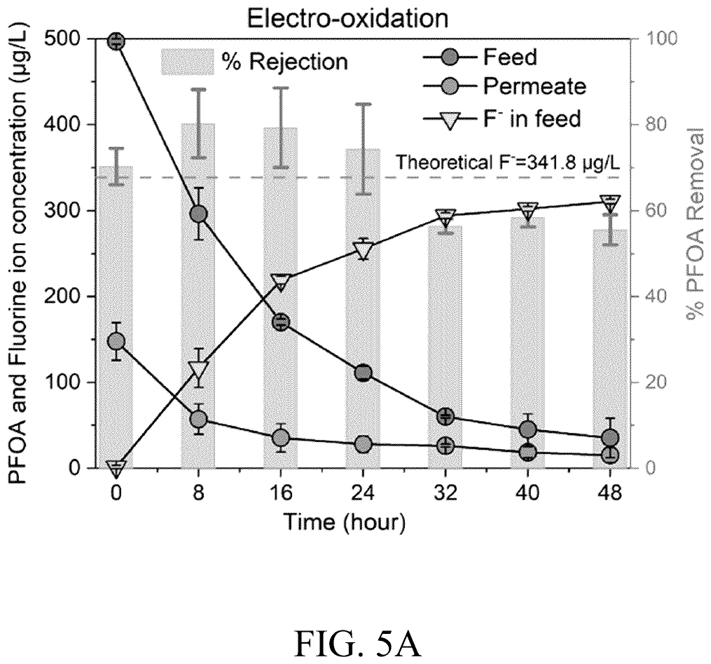

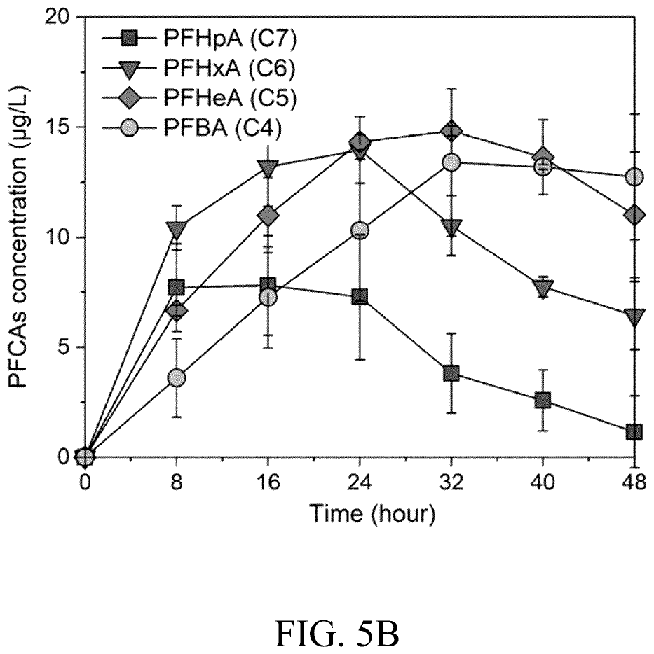

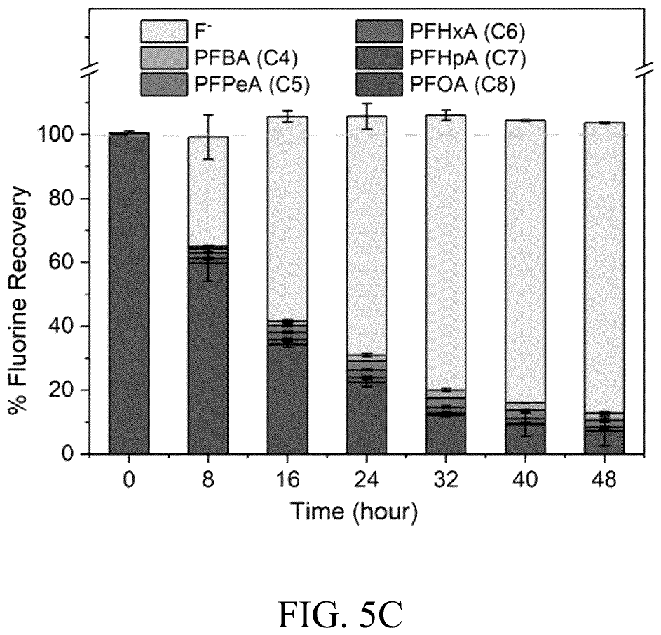

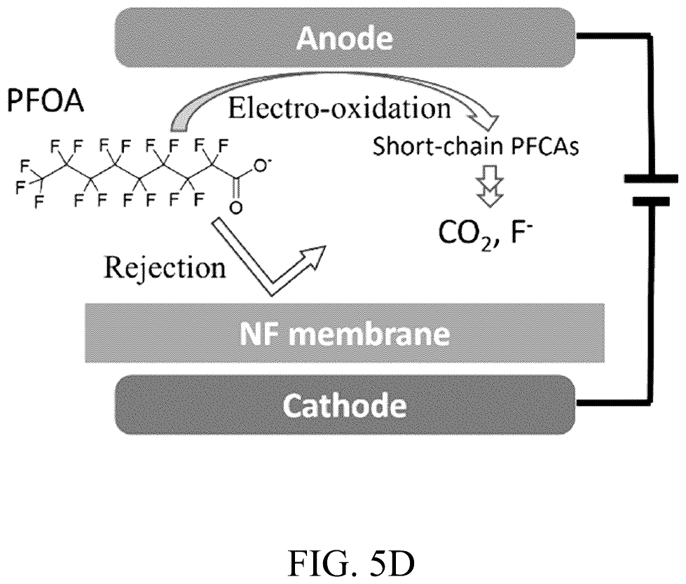

Long-term (48 hour) filtration tests, as shown in FIGS. 4A-5D, were carried out to investigate the stability of the electric field-assisted nanofiltration system. The PFOA concentration in the feed tank and permeate, along with membrane fouling and PFOA deposition on membrane system parts, were examined to explore the possible mass loss in the membrane system. With the non-saline feed, the percent PFOA rejection of the electric field-assisted group (average 97.5%, shown in FIG. 4B) was higher than that of the control group (average 56.6%, shown in FIG. 4A), and the filtration performance was found to be both stable. Three mechanisms may explain the improved rejection from the electric field: (1) the electric field causes electromigration of PFOA away from the membrane, (2) electro-absorption of PFOA on the electrodes, and (3) membrane fouling enhancement. A ˜40% reduction in the PFOA concentration of the feed tank was observed after 48 hours in the control group, shown in FIG. 4A, proving that PFOA may foul on the NF membrane. However, the percent rejection did not change over time, and the PFOA concentration of permeate decreased. Additionally, when the electric field was applied, shown in FIG. 4B, PFOA in the feed tank was reduced by only 23%, indicating that the electric field could reduce the PFOA fouling on the membrane and electro-absorption did not significantly remove PFOA from the feed. Therefore, the dominant mechanism for increased rejection is likely that applying the electric field can pull the PFOA away from the membrane surface due to electromigration.

### E. Filtration and Degradation Performance in a Saline Feed

Most water streams contain enough salt to enable electro-oxidation at electrodes experiencing an electric field. Therefore, filtration stability, PFOA concentration, and degradation products were investigated to confirm the possible degradation and effects of water electrolysis. One millimolar sodium sulfate was used in the saline feed to represent the salinity of natural surface water and tap water. Electrocatalytic water splitting involving an oxygen evolution reaction at the anode and a hydrogen evolution reaction at the cathode leads to a change of pH. With the increase of applied voltage, the current density in the saline feed increased significantly while the current density in the non-saline feed remained low, and the pH of the permeate significantly shifted toward alkaline, and the feed solution slowly turned acidic, which suggests that the electrolysis reaction was significant in the saline feed trials. Further, shown in FIG. 5A, the PFOA removal in the saline feed was lower than that in the non-saline feed, and the filtration performance was unstable and fluctuated between 55% and 80%. A possible reason for the lower and erratic PFOA removal in the saline feed is that PFOA, as an amphiphilic surfactant, accumulated at the water-air interface on the bubbles formed via water electrolysis, which may have weakened the effect of the electric field driving force.

The destruction of PFOA by electro-oxidation produces fluoride ions (F) and short-chain perfluoro carboxylic acids (PFCAs). The F⁻ concentration in the feed tank gradually increased as the PFOA was slowly degraded and approached the theoretical fluoride ion concentration (341.8 μg/L) after 48 h of operation (see, FIG. 5A), which suggests high defluorination of PFOA. Short-chain PFCAs include PFBA (C₃F₇COOH, C4), PFPeA (C₄F₉COOH, C5), PFHxA (C₅F₁₁COOH, C₆), and PFHpA (C₆F₁₃COOH, C₇) and were below 15 μg/L in the feed tank and showed a trend of “generation-accumulation degradation” (see, FIG. 5B). The fluorine recovery, shown in FIG. 5C, indicated that more than 90% of PFOA was defluorinated and released F⁻ at the end of the process. Nearly 100% recovery suggests that the fluorine-containing degradation products obtained from PFOA were mainly short-chain PFCAs and F⁻. According to past studies, the degradation of PFOA in a saline solution begins with the direct electron transfer (DET) of hydrolyzed PFOA (C₇F₁₅COO⁻) on the anode surface, where PFOA is attacked by SO₄⁻ (produced by the anode), causing the compound to become C₇F₁₅COO·; next the Kolbe reaction decarboxylates C₇F₁₅COO·to form C₇F₁₅·and then, the C₇F₁₅·reacts with ·OH, O₂, or SO₄⁻ to generate C₇F₁₅OH. The C₇F₁₅OH is thermodynamically unstable and undergoes molecular rearrangement to form C₆F₁₃COF; then, C₆F₁₃COF becomes hydrolyzed to unzip one CF₂ and release F. Stepwise chain shortening of PFOA thus occurs, causing mineralization to CO₂ and F. As shown in FIG. 5D, PFOA was simultaneously rejected and degraded in the saline feed by membrane separation and electro-oxidation.

### F. Water Flux and Energy Consumption

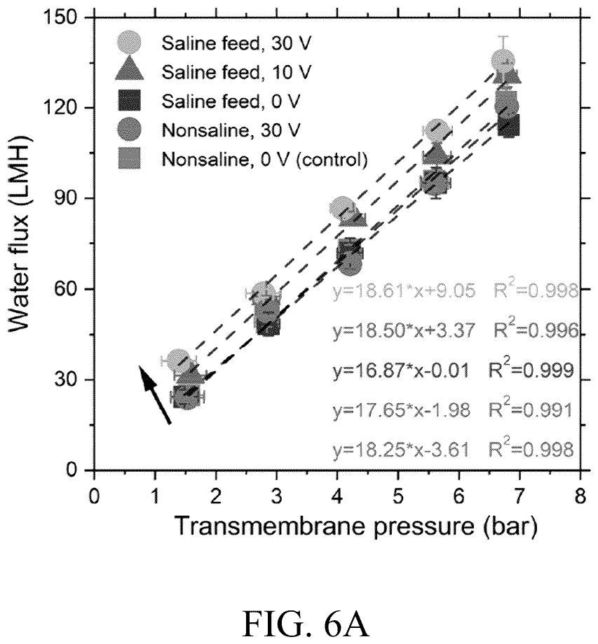

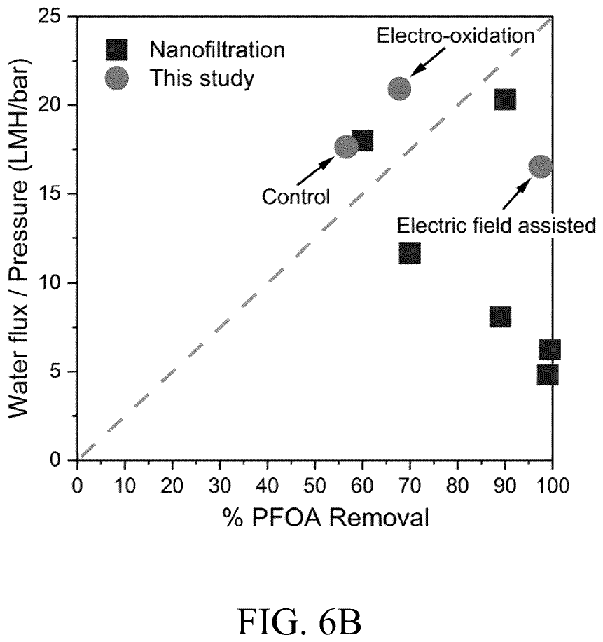

To understand the approach's applicability, permeate water flux and energy consumption after applying an electric field were investigated. The NF membrane used in this study has a range for water flux of 20-122 LMH (L/m² hr) at a transmembrane pressure range of 1.5-6.8 bar (see, FIG. 6A). However, applying the electric field to a non-saline feed (30 V, 68.4 LMH at 4.20 bar) slightly reduced water flux compared to the control group (0 V, 73.0 LMH at 4.20 bar); the current density was around 3 mA/cm² in saline feed, but no significant current was detected in the non-saline feed. Nevertheless, the oxygen evolution reaction caused the generation of oxygen gas in the anode chamber within the saline feed. Mixing the gas phase in the influent led to the conversion of single-phase liquid flow filtration into a two-phase liquid-gas filtration, which significantly increased the water flux (30 V, 86.6 LMH at 4.09 bar). The level of PFOA rejection and water flux in various membrane technologies are shown in FIG. 6B; it shows that some nanofiltration could meet high PFOA rejection (>99%) but possess poor water flux. Therefore, the described improved membrane system (100) achieved a 97.5% average PFOA rejection at a water flux of 68.4 LMH.

The NF system (100) (in the non-saline feed) mainly consumed electrical energy (excluding pumping energy) by energizing the electric field. However, additional electrical energy was required for electrolysis reactions in the saline feed. Electric energy per order (E_{EO}, kWh/m³/order) was used to evaluate the energy consumption of advanced oxidation processes. This metric estimates the electric energy cost per cubic meter of permeate, normalized by per logarithmic PFOA removal. The calculation method was shown as follows:

$${E}_{E O} = \frac{{U}_{c e l l} I}{Q lg ( \frac{{C}_{f}}{{C}_{p}} )} ,$$

where U_{cell} is the applied voltage (V), I is the cell current (A), Q is the permeate water volume per hour (m³/h), and Cf and Cp are the PFOA concentrations in the feed tank and permeate.

The low electrical conductivity of non-saline feed allowed the proposed system to require electric field energy of 7.31×10⁻⁵ kWh/m³/order, which is extremely low compared to other membrane technologies. Due to the flow passing through the anode pores, the mass transfer can be optimized, thus enhancing the degradation rate. Additionally, the high rejection of PFOA by membrane separation can further reduce the energy consumption. In batch mode, the system (100) has an exceptionally low energy consumption (0.0224 kWh/m³/order) for destroying PFOA, while achieving a higher water flux in the saline feed and achieving simultaneous rejection and degradation of PFOA. In contrast, while many past advanced oxidation/reduction processes have been capable of eliminating PFCAs in water, their specific energy consumption falls within the several thousand kWh/m³ range. While the above neglects to pump energy, there is a key trade-off between the membrane selectivity and its energy consumption from pumping. More selective membranes, such as for reverse osmosis (RO), have denser function layers and smaller MWCO than NF, producing a lower permeate flux and higher energy consumption while operating at a higher transmembrane pressure. RO would also trap harmless ions we wish to pass through, such as F⁻ or Cl⁻, and thus creates a waste concentrate stream, limiting its use for wastewater treatment. Therefore, the improved membrane design described herein outperforms RO by achieving similar rejection, >99% PFOA rejection, and superior flux of >15 LMH/bar and could avoid creating a concentrate waste stream and destroying PFAS.

### G. Environmental Implications

Today, most available membrane technologies may be able to reject toxic compounds into waste streams, but they fail to destroy them, therefore risking further contamination. This drawback of conventionally used membrane technologies may be resolved by introducing advanced oxidation processes to treat the effluent, although they conventionally only treat the pure permeate. Moreover, the practical application of membrane technology requires consideration of the cost of use, water flux, and energy consumption. The anode-membrane-cathode sandwich structured membrane system described herein allows for operation in two feedwater modes. In the non-saline feed (e.g., drinking water), the system addresses the challenges of simultaneously achieving excellent rejection, low energy consumption, and high-water flux; In the saline feed (e.g., surface water), the water flux was improved and contaminants could be degraded. The proposed electric field-assisted nanofiltration expands the application range of electrochemical water treatment technology and offers a new separation method to efficiently remove the ionized organic contamination; furthermore, the system has the possibility to act as a reactive electrochemical membrane to degrade contaminants in the feed.

### IV. Exemplary Alternative Embodiments of Electric Field-Assisted Nanofiltration Systems

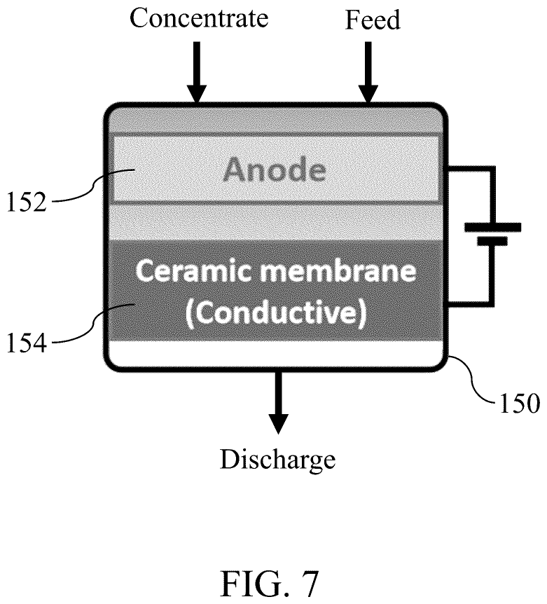

Shown in FIG. 7 is an alternative membrane cell (150) for use with the systems of FIGS. 1A and 1D. Similarly, the membrane cell (150) is defined by a fluid tight enclosure housing an anode (152) and a cathode (154) within. The cathode (154) is a conductive ceramic electrode, and the anode material is preferably a porous membrane electrode (e.g., porous titanium metal or alumina ceramic membranes coated with metal oxides, or a titanium oxide-based membrane). The anode (152) materials may be any of the materials previously described with reference to FIGS. 1A and 1D.

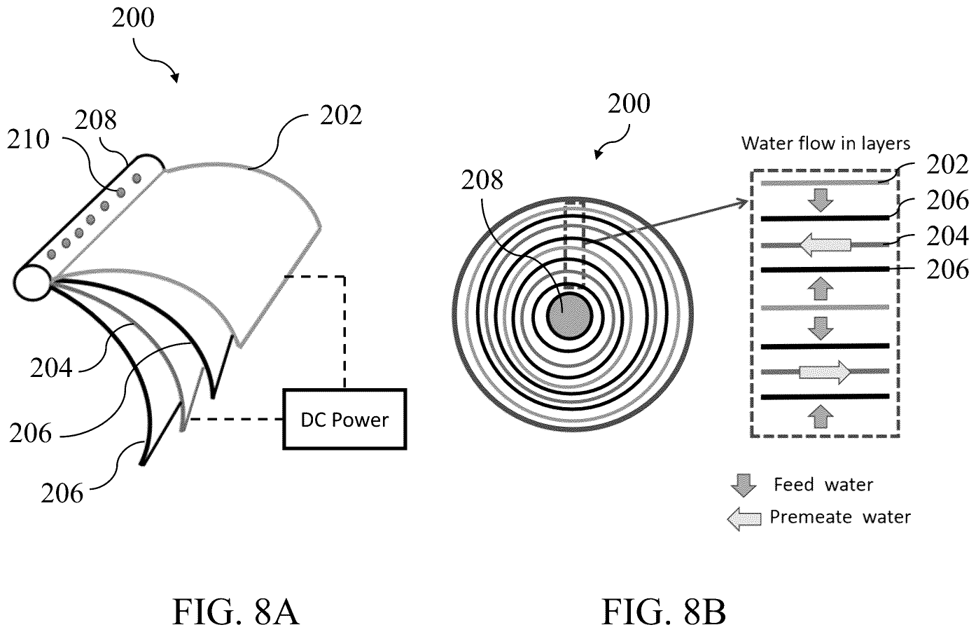

Shown in FIGS. 8A-8B is another example embodiment of a nanofiltration system (200) operable according to the same functional principles as described above with reference to FIGS. 1A and 1D. Commercial polymer membranes may be used, including, and not limited to, polyethersulfone, polyamide, and polyvinylidene fluoride. However, both the anode and cathode may be conductive carbon-based materials (e.g., graphene, carbon nanotubes, carbon paper, and carbon fiber). The membrane module is rolled and assembled in a “membrane-cathode-membrane-anode” form, with the cathode acting as a gap in this design. The above materials are selected based on conductive, flexibility, stability in electrochemical environments and compatibility with the system design.

To that end, the system (200) includes an anode (202), cathode (204), and one or more membranes (206) which may be coupled at one end (e.g., via a central pipe (208)), and folded around the central pipe (208) as shown in FIG. 1F. As such, feed water may be run through the central pipe (208) to exit through one or more holes or slits (210), and to pass through the anode (202), membrane(s) (206), and cathode (204) layers. The anode (202) and cathode (204) may be formed of a carbon material such as carbon felt or paper. Further, the anode (202) and cathode (204) may function as spacers. Thus, the system (200) is compact and flexible and could be applied to water or other liquid supply piping systems.

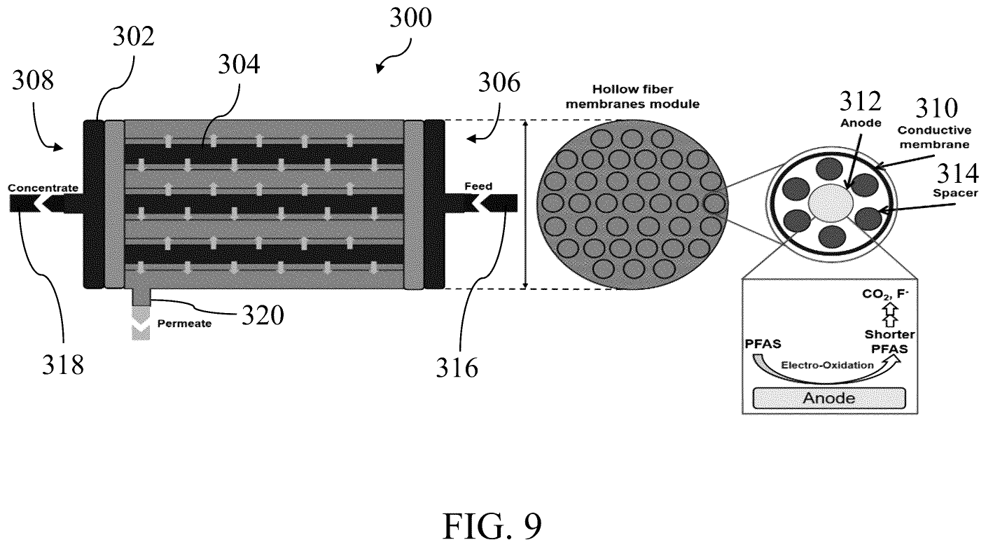

Shown in FIG. 9 is another example embodiment of a nanofiltration system (300) operable according to the same functional principles as described above with reference to FIG. 7. The system (300) includes an enclosure (302) having a plurality of hollow fibers (304) within, the fibers (304) being hollow at their core and having a porous ceramic wall structure. Commercial hollow fiber ceramic membranes may be used for the fibers (304), such as aluminum oxide ceramic membrane, coated with a metal or conductive polymers to act as a cathode. The enclosure (302) creates a large surface area for fluid (e.g., water) to flow through from a first end (306) (e.g., through a feed port (316)) to a second end (308) (e.g., through a concentrate port (318)), whereby permeate exits the enclosure through a permeate port (320) in the side wall. The hollow interior of the fibers (304) allow fluid to pass either from the outside of the fibers (304) to the inside (outside-in flow) or vice versa (inside-out flow).

Further, each hollow fiber (304) includes an anode (312) axially positioned within, and one or more spacers (314) separating the anode (312) from the ceramic membrane (310). The anode (312) may be formed as a titanium-based rod that fits inside the hollow fiber membrane (304), by applying conductive coatings (e.g., metal oxides and carbon materials). The noted materials for the fibers (304) and the anode (312) may be selected based on the conductive, stability in electrochemical environments, and compatibility with the system design.

Reference systems that may be used herein can refer generally to various directions (for example, upper, lower, forward and rearward), which are merely offered to assist the reader in understanding the various embodiments of the disclosure and are not to be interpreted as limiting. Other reference systems may be used to describe various embodiments, such as those where directions are referenced to the portions of the device, for example, toward or away from a particular element, or in relations to the structure generally (for example, inwardly or outwardly).

While examples, one or more representative embodiments and specific forms of the disclosure have been illustrated and described in detail in the drawings and foregoing description, the same is to be considered as illustrative and not restrictive or limiting. The description of particular features in one embodiment does not imply that those particular features are necessarily limited to that one embodiment. Some or all of the features of one embodiment can be used in combination with some or all of the features of other embodiments as would be understood by one of ordinary skill in the art, whether or not explicitly described as such. One or more exemplary embodiments have been shown and described, and all changes and modifications that come within the spirit of the disclosure are desired to be protected.

I/We claim:

1. A fluid filtration apparatus, comprising:
(a) a fluid reservoir defining an external surface and an interior cavity, wherein the interior cavity defines opposing end walls;
(b) a filtration membrane positioned within the fluid reservoir spanning between the interior opposing end walls, wherein the filtration membrane fluidly divides the fluid reservoir into a first fluid cavity and a second fluid cavity;
(c) a porous anode positioned within the first fluid cavity, wherein the porous anode is configured to selectively receive a first power signal thereto;
(d) a porous cathode positioned within the second fluid cavity, wherein the porous anode is configured to selectively receive a second power signal thereto;
(e) a first fluid port disposed through the external surface of the fluid reservoir and configured to fluidly couple with the first fluid cavity; and
(f) a second fluid port disposed through the external surface of the fluid reservoir and configured to fluidly couple with the second fluid cavity.

2. The fluid filtration apparatus of claim 1, wherein the first fluid port is configured to transfer an inlet fluid into the fluid reservoir and the second fluid port is configured to transfer permeate fluid out of the fluid reservoir, wherein the permeate fluid is defined as a filtered portion of the inlet fluid.

3. The fluid filtration apparatus of claim 2, comprising a third fluid port disposed through the external surface of the fluid reservoir and configured to fluidly couple with the first fluid cavity, wherein the third fluid port is configured to transfer a concentrate fluid out of the fluid reservoir, wherein the concentrate fluid is defined as an unfiltered portion of the inlet fluid.

4. The fluid filtration apparatus of claim 1, comprising a power source coupled with the anode and the cathode, wherein the power source is configured to selectively provide the first and second power signals to the anode and the cathode to generate an electric potential between the anode and the cathode.

5. The fluid filtration apparatus of claim 1, comprising a spacer disposed between the anode and the filtration membrane.

6. The fluid filtration apparatus of claim 5, wherein the spacer includes a plastic mesh material.

7. The fluid filtration apparatus of claim 1, wherein the filtration membrane includes a nanofiltration material.

8. The fluid filtration apparatus of claim 1, wherein the porous anode is formed of a porous base material layer coated with antimony-doped tin dioxide (SnO₂—Sb).

9. The fluid filtration apparatus of claim 8, wherein the porous base material layer includes a metal.

10. The fluid filtration apparatus of claim 1, wherein the porous anode is formed of a porous carbon material.

11. The fluid filtration apparatus of claim 1, wherein a surface of the porous cathode contacts and provides support for the filtration membrane to rest upon the porous cathode.

12. The fluid filtration apparatus of claim 1, wherein the porous cathode is formed of a porous titanium metal or a carbon-based material.

13. A fluid filtration apparatus, comprising:
(a) an elongate fluid conduit having an open inlet end for receiving fluid, and a plurality of perforations along its length;
(b) a power source;
(c) a plurality of planar sheets each composed of a porous material, each having a first edge secured to the elongate fluid conduit proximate to the perforations and a second edge configured to be wrapped around the conduit to form multiple overlapping layers covering the perforations, wherein a fluid introduced into the conduit is configured to exit through the perforations and pass through one or more of the plurality of planar sheets, wherein the plurality of planar sheets includes:
(i) an anode sheet coupled with the power source;
(ii) a cathode sheet coupled with the power source, wherein the power source is configured to apply a voltage potential between the anode sheet and the cathode sheet;
(iii) a first filtration sheet; and
(iv) a second filtration sheet.

14. The apparatus of claim 13, wherein the plurality of planar sheets is arranged in the following order:
(a) the anode sheet,
(b) the first filtration sheet,
(c) the cathode sheet; and
(d) the second filtration sheet.

15. The apparatus of claim 13, wherein the perforations are arranged in a linear pattern.

16. The apparatus of claim 13, wherein the anode sheet and the cathode sheet are formed of a carbon material.

17. The apparatus of claim 13, wherein the first filtration sheet and the second filtration sheet are formed of polymer materials.

18. A fluid filtration apparatus, comprising:
(a) a fluid reservoir defining an external surface and an interior cavity, wherein the interior cavity defines opposing first and second end walls;
(b) a power source;
(c) an anode positioned within the interior cavity spanning from the first end wall to the second end wall, wherein the anode is configured to selectively receive a first power signal thereto from the power source;
(d) a ceramic conductive membrane positioned within the interior cavity adjacent to the anode and spanning from the first end wall to the second end wall, wherein the ceramic conductive membrane is configured to selectively receive a second power signal thereto from the power source;
wherein the anode and cathode are each formed of porous materials.

19. The fluid filtration apparatus of claim 18, wherein the anode is formed of a porous titanium metal or alumina ceramic membrane coated with a metal oxide.

20. The fluid filtration apparatus of claim 18, wherein the anode is formed of a titanium oxide-based membrane.
